(19) United States
(12) Patent Application Publication
(10) Pub. No.: US 2023/0137748 A1
(43) Pub. Date: May 4, 2023

(54) METHOD, APPARATUS, AND COMPUTER-READABLE RECORDING MEDIUM FOR IMAGE PRE-PROCESSING BASED ON DOCUMENT QUALITY

(71) Applicant: SAMSUNG SDS CO., LTD., Seoul (KR)

(72) Inventors: Hyoseob SONG, Seoul (KR); Seongho JOE, Seoul (KR); Youngjune GWON, Seoul (KR)

(73) Assignee: SAMSUNG SDS CO., LTD., Seoul (KR)

(21) Appl. No.: 17/973,215

(22) Filed: Oct. 25, 2022

(30) Foreign Application Priority Data
Oct. 29, 2021 (KR) 10-2021-0147380

(51) Int. Cl. G06T 7/00; G06V 30/19; G06V 30/16

(52) U.S. Cl. CPC G06T 7/0002; G06V 30/16; G06V 30/19173; G06T 2207/10024; G06T 2207/30168; G06T 2207/30176

(57) ABSTRACT

The present disclosure relates to document quality-based image pre-processing that measures, for each item, the quality of an input document image that is to be analyzed and omits a part or the entirety of a pre-processing process, or performs an image pre-processing process to which an appropriate algorithm is applied, so that an unnecessary operation may be decreased and a processing time may be reduced, and a higher character recognition rate may be obtained than an image pre-processing process uniformly applied. A document quality-based image pre-processing method according to an embodiment of the present disclosure may be a document quality-based image pre-processing method performed by a processor in an apparatus, the method including measuring a document quality of an input document image, classifying the document quality, and performing image pre-processing corresponding to the document quality classified for the document image.

### CROSS REFERENCE TO RELATED APPLICATION(S)

This application is based on and claims priority under 35 U.S.C. 119 to Korean Patent Application No. 10-2021-0147380, filed on Oct. 29, 2021, in the Korean Intellectual Property Office, the disclosure of which is herein incorporated by reference in its entirety.

### BACKGROUND OF THE INVENTION

### 1. Field of the Invention

The present disclosure relates to document quality-based image pre-processing. Particularly, the present disclosure relates to document quality-based image pre-processing that measures, for each item, the quality of an input document image that is to be analyzed and omits a part or the entirety of a pre-processing process with respect to an image classified as a high-quality image among input document images classified based on each quality, or may perform an image pre-processing process to which an appropriate algorithm is applied in the case of a medium-quality document image or a low-quality document image, so that an unnecessary operation may be decreased and a processing time may be reduced, and a higher character recognition rate may be obtained than an image pre-processing process uniformly applied.

### 2. Description of the Prior Art

Conventional document data image pre-processing uniformly applies pre-processing without taking into consideration the characteristic of an input document image and thus, unnecessary pre-processing may be performed in the case of a high-quality document image, or more suitable pre-processing may not be applied in the case of a low-quality document image. Accordingly, the performance of character recognition is low, which is drawback.

Therefore, there is a desire for a method of improving the performance of recognizing a character or a document by applying a document image pre-processing method differently depending on the quality of an input document image in the case of performing character or document recognition.

### SUMMARY OF THE INVENTION

An aspect of the present disclosure is to provide a document quality-based image pre-processing method and apparatus that may measure, for each item, the quality of an input document image that is to be analyzed and may omit a part or the entirety of a pre-processing process with respect to an image classified as a high-quality image among input document images classified based on each quality, or may perform an image pre-processing process to which an appropriate algorithm is applied in the case of a medium-quality document image or a low-quality document image, so that an unnecessary operation may be decreased and a processing time may be reduced, and a higher character recognition rate may be obtained than an image pre-processing process uniformly applied.

Another aspect of the present disclosure is to provide a document quality-based image pre-processing method and apparatus that may quantify the overall quality of an input document image as numeral values obtained based on appropriate quality measurement items, and may differently apply a pre-processing method depending on a result associated with each quality measurement item since a recognition result differs depending on the quality of an input document image in the case of performing character or document recognition, so that the performance of character or document recognition may be improved.

Another aspect of the present disclosure is to provide a document quality-based image pre-processing method and apparatus that may separately perform image pre-processing that has been uniformly applied to input document image data, as document image-based image pre-processing and character-based image pre-processing, may select an item for each case, and may apply an optimal algorithm among various pre-processing methods such as brightness adjustment, color change, rotation correction, filtering for noise cancellation, and the like in association with an input document image, so as to increase a final character recognition rate.

Another aspect of the present disclosure is to provide a document quality-based image pre-processing method and apparatus that may apply pre-processing that uses an appropriate algorithm depending on a document image quality score measured by taking into consideration the overall values measured for each document image-based attribute or character-based attribute, thereby increasing the performance of character recognition.

A first aspect of the present disclosure, there is provided a document quality-based image pre-processing method performed by a processor in an apparatus, the method including: measuring a document quality of an input document image; classifying the document quality; and performing image pre-processing corresponding to the document quality classified for the document image.

Preferably, the measuring of the document quality may include measuring the document quality based on at least one of an attribute of the document image and an attribute of a character included in the document image.

Preferably, the attribute of the document image may include at least one of a color distribution, a noise distribution, and a degree of rotation associated with the document image, and the attribute of the character may include at least one of a detectable character area ratio and a normal word detection ratio.

Preferably, the measuring of the document quality of the input document image may further include: detecting a character from the document image; and recognizing the detected character.

Preferably, the classifying of the document quality may include classifying, based on the measured document quality, the document quality of the input document image as one of a high quality, a medium quality, and a low quality.

Preferably, the performing of image pre-processing corresponding to the document quality classified for the document image, may include performing the entire pre-processing on the input document image in case that the document quality of the input document image is the low quality; omitting pre-processing related to at least one quality measurement item that contributes to classification of the document image as the medium quality in case that the document quality of the input document image is the medium quality; and omitting part or the entirety of the pre-processing in case that the document quality of the input document image is the high quality.

Preferably, the performing of the image pre-processing corresponding to the document quality classified for the document image may include, in case that the document quality of the input document image is the low quality or the medium quality, performing pre-processing using an optimal correction method among a plurality of correction methods used in pre-processing related to at least one quality measurement item that deteriorates the quality of the document image to the low quality or the medium quality.

Preferably, the measuring of the document quality of the input document image may further include obtaining a score of each quality measurement item for the input document image; and obtaining an average of the scores of the quality measurement items, and acquiring a document quality score, and the classifying of the document quality may include classifying, based on the document quality score, the document quality of the input document image as at least one of the high quality, the medium quality, and the low quality.

Preferably, the measuring of the document quality of the input document image may further include acquiring a document quality score for each of a plurality of input document images; and based on the document quality score of each of the plurality of document images, setting at least one of a low-quality group, a medium-quality group, and a high-quality group, and the classifying of the document quality may include classifying, based on the document quality score of the input document image and the set group, the document quality of the input document image as at least one of the low quality, the medium quality, and the high quality.

Preferably, the document quality of the document image is measured based on at least one of a color distribution score, a noise distribution score, a rotation score, a detectable character area score, and a normal word detection score obtained by quantifying the color distribution, the noise distribution, the degree of rotation, the detectable character area ratio, and the normal word detection ratio, respectively.

Preferably, the color distribution score may be obtained by (1-background area/entire image area), the noise distribution score may be obtained by (1-noise area/entire image area), the rotation score may be 0 in case that a degree of rotation of each edge of a document in the document image in a horizontal direction and a vertical direction is greater than a predetermined angle, and may be obtained by (100-10×degree of rotation) in case that the degree of rotation in the horizontal direction and the vertical direction is less than the predetermined angle, the detectable character area score may be obtained by (1-the number of character areas that are beyond a detectable area/the number of character areas), and the normal word detection score may be obtained by (1-the number of word areas where a character is missing/the number of word areas).

A second aspect of the present disclosure, there may be provided a document quality-based image pre-processing apparatus including a processor, and the processor performs measuring a document quality of an input document image; classifying the document quality; and performing image pre-processing corresponding to the document quality classified for the document image.

Preferably, the measuring of the document quality of the input document image may include measuring the document quality based on at least one of an attribute of the document image and an attribute of a character included in the document image.

Preferably, the attribute of the document image may include at least one of a color distribution, a noise distribution, and a degree of rotation associated with the document image, and the attribute of the character may include at least one of a detectable character area ratio and a normal word detection ratio.

Preferably, the measuring of the document quality of the input document image may further include detecting a character from the document image; and recognizing the detected character.

Preferably, the classifying of the document quality may include classifying, based on the measured document quality, the document quality of the input document image as at least one of a high quality, a medium quality, and a low quality.

Preferably, the performing of image pre-processing corresponding to the document quality classified for the document image may include performing entire pre-processing on the input document image in case that the document quality of the input document image is the low quality, omitting pre-processing related to at least one quality measurement item that contributes to classification of the document image as the medium quality in case that the document quality of the input document image is the medium quality, and omitting part or the entirety of the pre-processing in case that the document quality of the input document image is the high quality.

Preferably, the performing of the image pre-processing corresponding to the document quality classified for the document image may include, in case that the document quality of the input document image is the low quality or the medium quality, performing pre-processing using an optimal correction method among a plurality of correction methods used in pre-processing related to at least one quality measurement item that deteriorates the quality of the document image to the low quality or the medium quality.

Preferably, the measuring of the document quality of the input document image may further include obtaining a document quality score for each of a plurality of input document images; and based on the document quality score for each of the plurality of document images, setting at least one of a low-quality group, a medium-quality group, and a high-quality group, and the classifying of the document quality may include classifying, based on the document quality score of the input document image and the set group, the document quality of the input document image as at least one of the low quality, the medium quality, and the high quality.

A third aspect of the present disclosure, there may be provided a computer-readable storage medium that stores instructions which, when executed by a processor, cause an apparatus including the processor to perform an operation for document quality-based image pre-processing, the operation including: measuring a document quality of an input document image; classifying the document quality; and performing image pre-processing corresponding to the document quality classified for the document image.

A document quality-based image pre-processing method and apparatus according to an embodiment of the disclosure may measure, for each item, the quality of an input document image that is to be analyzed and may omit a part or the entirety of a pre-processing process with respect to an image classified as a high-quality image among input document images classified based on each quality, or may perform an image pre-processing process to which an appropriate algorithm is applied in the case of a medium-quality document image or a low-quality document image, so that an unnecessary operation may be decreased and a processing time may be reduced, and a higher character recognition rate may be obtained than an image pre-processing process uniformly applied.

In addition, a document quality-based image pre-processing method and apparatus according to an embodiment of the present disclosure may quantify the overall quality of an input document image as numeral values obtained based on appropriate quality measurement items, and may differently apply a pre-processing method depending on a result associated with each quality measurement item since a recognition result differs depending on the quality of an input document image in the case of performing character or document recognition, so that the performance of character or document recognition may be improved.

In addition, a document quality-based image pre-processing method and apparatus according to an embodiment of the present disclosure may separately perform image pre-processing that has been uniformly performed on input document image data, as document image-based image pre-processing and character-based image pre-processing, may select an item for each case, and may apply an optimal algorithm among various pre-processing methods such as brightness adjustment, color change, rotation correction, filtering for noise cancellation, and the like in association with an input document image, so as to increase a final character recognition rate.

In addition, a document quality-based image pre-processing method and apparatus according to an embodiment of the present disclosure may apply pre-processing that uses an appropriate algorithm depending on a document image quality score measured by taking into consideration the overall values measured for each document image-based attribute or character-based attribute, thereby increasing the performance of character recognition.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating a normal image pre-processing process performed on a document image;

FIG. 2 is a flowchart illustrating a document quality-based image pre-processing method according to an embodiment of the present disclosure;

FIG. 3 is a detailed flowchart illustrating a document quality measurement operation illustrated in FIG. 2.

FIG. 4 is a diagram illustrating an example of an attribute item for measuring a document image quality;

FIG. 5 is a diagram illustrating an example of measuring the degree of rotation of a document by detecting a line;

FIG. 6 is a diagram illustrating an example of measuring the degree of rotation of a document using a character boundary area;

FIGS. 7 and 8 are diagrams illustrating an example of a change in a pre-processing process according to a document image quality measurement result;

FIG. 9 is a diagram illustrating a document quality-based image pre-processing apparatus according to an embodiment of the present disclosure; and

FIG. 10 is a diagram illustrating a document quality-based image pre-processing apparatus according to another embodiment of the present disclosure.

### DETAILED DESCRIPTION OF THE EXEMPLARY EMBODIMENTS

Hereinafter, various embodiments will be described in detail with reference to the accompanying drawings. The purposes, specific advantages, and new features of the present disclosure may be clearly understood from detailed descriptions and preferable embodiments associated with the attached drawings.

Terms or words used in the present specification and claims, which are concepts appropriately defined by an inventor in order to describe the disclosure best, should be construed as the meaning and concepts that agree with the technical idea of the present disclosure, and the terms and words are merely to describe embodiments but should not be understood as limiting the present disclosure.

When assigning reference numerals to elements, like reference numerals may refer to like or similar elements, and duplicate description thereof will be omitted. Ending words used for an element, such as “module” and “unit”, are assigned or interchangeably used for ease of drafting the specifications, may not have distinguishing meanings or roles, and may be software or hardware elements.

When describing elements of the present disclosure, an element expressed in the singular form is intended to include elements expressed in the plural forms as well, unless otherwise described. In addition, it should be understood that the terms “first”, “second”, and the like are used for distinguishing one element from another element, and elements are not limited to the above-mentioned terms. In addition, in case that an element is connected to another element, yet another element may be connected between the element and the other element.

In addition, when detailed descriptions related to a well-known related technical art is identified as making the spirits of the embodiments disclosed in the present specification ambiguous, the detailed descriptions thereof will be omitted herein. In addition, the attached drawings are merely for help a sufficient understanding of embodiments disclosed in the present specification, and it should be understood, however, that there is not intended to limit example embodiments to the particular forms disclosed, but to the contrary, embodiments should be construed as including all modifications, equivalents, and alternatives falling within the scope of the embodiments.

Hereinafter, a document quality-based image pre-processing method and apparatus according to an embodiment of the present disclosure will be described with reference to attached drawings.

Image pre-processing of input document image data, that is, an input document image, which has been conventionally uniformly applied, may separately perform the image pre-processing as document image-based image pre-processing and character-based image pre-processing, may select a measurement item for each case, and may apply an optimal algorithm among methods used in various pre-processing operations such as brightness correction, color correction, rotation correction, filtering for noise cancellation, and the like associated with the input document image, and thus, a final character recognition rate may be increased.

In this instance, measurement items for the document image may include a color distribution, a noise distribution, the degree of rotation, and the like, and measurement items for the character may include a ratio of a detectable character area and a detection ratio of a normally detected word.

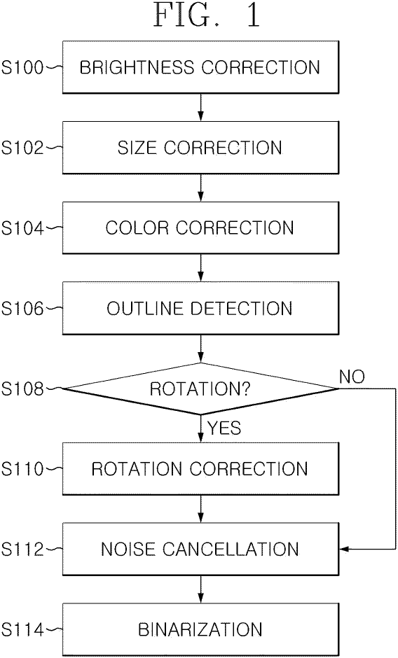

FIG. 1 is a diagram illustrating an example of a normal image pre-processing process performed on an input document image, which is performed before character recognition, and the order of operations may be changeable.

The normal image pre-processing process illustrated in FIG. 1 may include brightness correction operation S100 that adjusts the brightness of a document image, size correction operation S102 that adjusts a size, color correction operation S104 that changes a color, outline detection operation S106 that detects the outline of a document image, rotation determination operation S108 that determines whether rotation occurs based on the detected outline, rotation correction operation S110 that rotates a document in case that a document in a document image rotates, noise cancellation operation S112 that cancels noise from the document image, and binarization operation S114 that binarizes the document image.

In case that the quality of an input document image is not taken into consideration, a method that fixedly uses an algorithm applied to each operation in the series of operations as shown in FIG. 1 as a representative algorithm, and performs all processes, is a method generally used in an image pre-processing process performed on an input document image.

For example, a binarization operation may be performed on an input document image that does not necessarily need binarization, or a result obtained via a relatively complex operation may be used, such as an OTSU binarization algorithm performed on an input document image for which binarization processing can have been simply performed by applying a threshold value.

In the present disclosure, a character recognition rate may be improved by selecting at least one item capable of measuring the quality of an input document image, quantifying the quality for each item, and applying an appropriate algorithm based on the quality, or the performance of character recognition may be improved by omitting an unnecessarily operation and performing efficient pre-processing on an input document image.

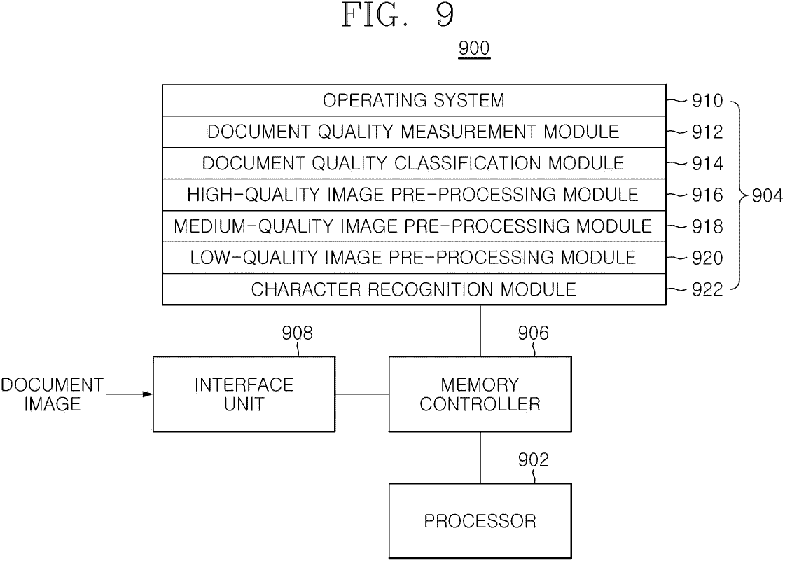

FIG. 9 is a diagram illustrating an apparatus 900 to which a method suggested in the present disclosure is applicable.

Referring to FIG. 9, the apparatus 900 may be configured to implement a process according to a document quality-based image pre-processing method according to an embodiment of the disclosure. For example, the apparatus 900 may be the computing device 900 that provides image pre-processing based on a document quality.

For example, the apparatus 900 to which the method suggested in the present disclosure is applicable may include a network device such as a repeater, a hub, a bridge, a switch, a router, a gateway, and the like, a computer device such as a desktop computer, a workstation, and the like, a mobile terminal such as a smartphone and the like, a portable device such as a laptop computer and the like, electronic appliance such a digital TV and the like, and means of transportation such as a vehicle and the like. As another example, the apparatus 900 to which the present disclosure is applicable may be included as a part of an application specific integrated circuit (ASIC) embodied in the form of a system on chip (SoC).

The document quality-based image pre-processing apparatus 900 according to an embodiment of the disclosure may include a processor 902 for controlling operation of the document quality-based image pre-processing apparatus 900, a memory 904 connected to the processor 902 via a memory controller 906, and an interface unit 908.

The memory 904 may be operatively connected to the processor 902, may store programs and/or instructions for processing and controlling the processor 902, and may store data and information used in the present disclosure, control information required for processing data and information according to the present disclosure, and temporary data generated in a data and information processing process, and the like. The memory 904 may be embodied as a storage device such as read only memory (ROM), random access memory (RAM), erasable programmable read only memory (EPROM), electrically erasable programmable read-only memory (EEPROM), flash memory, static RAM (SRAM), hard disk drive (HDD), solid state drive (SSD), and the like.

The processor 902 may be operatively connected to the memory 904 and/or the interface unit 908, and may control the operation of each module in the apparatus 900. Particularly, the processor 902 may perform various control functions for implementing the method suggested in the present disclosure. The processor 902 may be also referred to as a controller, a microcontroller, a microprocessor, a microcomputer, and the like. The method suggested in the present disclosure may be implemented by hardware, firmware, software, or a combination thereof. In the case of implementing the present disclosure using hardware, an application specific integrated circuit (ASIC) or a digital signal processor (DSP), a digital signal processing device (DSPD), a programmable logic device (PLD), a field programmable gate array (FPGA), and the like configured to implement the present disclosure may be included in the processor 902. In the case of implementing the method suggested in the present disclosure using firmware or software, the firmware or software may include instructions related to a module that performs functions or operations needed for implementing the method suggested by the present disclosure, a procedure, a function, or the like, and the instructions may be stored in the memory 904 or may be stored in a computer-readable recording medium (not illustrated) separately from the memory 904, and may be configured to cause the apparatus 900 to implement the method suggested in the present disclosure when the instructions are executed by the processor 902.

In addition, the apparatus 900 may include the interface unit 908. The interface unit 908 may be operatively connected to the processor 902, and the processor 902 may control the interface unit 908 so as to transmit or receive a wired/wireless signal that carries information and/or data, a signal, a message, and the like via a wired/wireless network. The interface unit 908 may support various communication standards, for example, IEEE 802 series, 3GPP LTE (LTE-A), 3GPP 5G, and the like, and may transmit or receive control information and/or data signals according to a corresponding communication standard. The interface unit 908 may be embodied outside the device 900 when needed.

In addition, the processor 902 may perform a function of performing various functions and processing data by executing various software programs and a set of instructions stored in the memory 904.

In addition, the memory 904 may further include a storage device located by being spaced apart from the processor 902, a network attach-type storage device that performs access via a communication network such as the Internet or the like.

The memory 904 may include one or more modules configured to be executed by the processor 902, and the one or more modules may include a document quality measurement module 912 for measuring a document quality of an input document image, a document quality classification module 914 for classifying the document quality, and image pre-processing modules 916, 918, and 920 for performing image prep-processing corresponding to the document quality classified for the document image.

In addition, the memory 904 may further include an operating system 910 including instructions for controlling the overall operation of the document quality-based image pre-processing apparatus 900 according to an embodiment of the present disclosure and a character recognition module 922 that recognizes a character from a pre-processed document image.

In addition, the image pre-processing modules 916, 918, and 920 may include the high-quality image pre-processing module 916, the medium-quality image pre-processing module 918, and the low-quality image pre-processing module 920.

In addition, the interface unit 908 may input a document image and may output a pre-processed document image or a character recognized from+ the pre-processed document image, and may connect a network or a peripheral input/output device to the processor 902 or the memory 904, and the memory controller 906 may perform a function of controlling memory access in case that the processor 902 or the interface unit 908 accesses the memory 904. According to an embodiment, the processor 902, the memory 904, the memory controller 906, and the interface unit 908 may be embodied as a single chip or as separate chips.

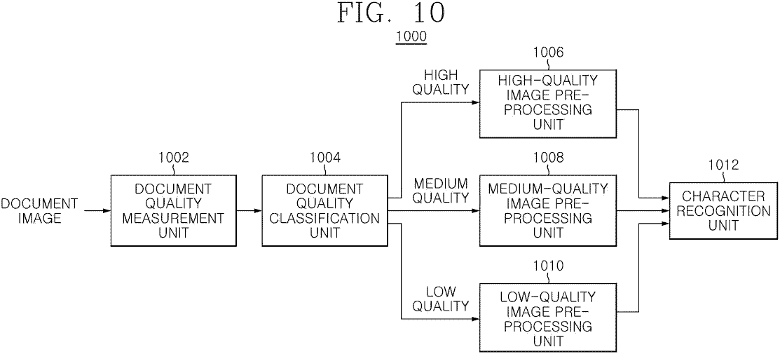

A document quality-based image pre-processing apparatus 1000 according to another embodiment of the present disclosure illustrated in FIG. 10 may include a document quality measurement unit 1002 that measures a document quality of an input document image, a document quality classification unit 1004 that classifies the document quality, and image pre-processing units 1006, 1008, and 1010 that perform image pre-processing corresponding to the document quality classified for the document image.

In addition, the document quality-based image pre-processing apparatus 1000 according to another embodiment of the disclosure may further include a character recognition unit 1012 that recognizes a character from a pre-processed document image.

In addition, the image pre-processing units 1006, 1008, and 1010 may include the high-quality image pre-processing unit 1006, the medium-quality image pre-processing unit 1008, and the low-quality image pre-processing unit 1010.

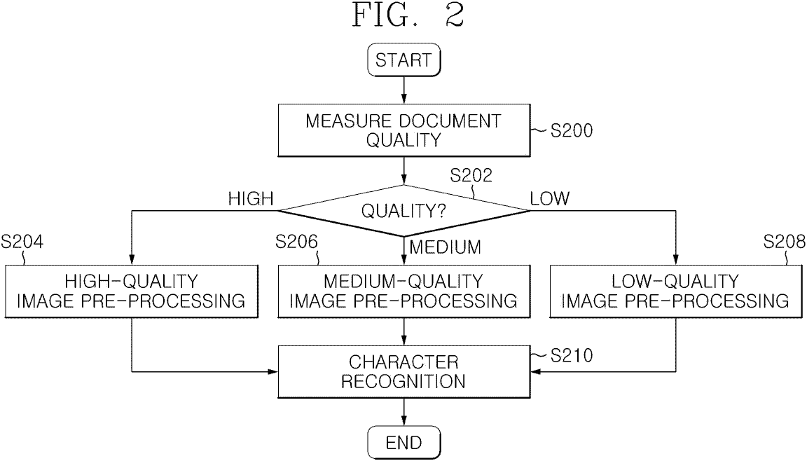

FIG. 2 is a flowchart illustrating a document quality-based image pre-processing method according to an embodiment of the present disclosure. The operations illustrated in FIG. 2 in an embodiment of the present disclosure may be performed by the document quality-based image pre-processing apparatus 900 and 1000 mentioned in FIG. 9 and/or FIG. 10 and descriptions related to the drawings.

In operation S200, the document quality measurement unit 1002 may measure a document quality of an input document image.

A document quality-based image pre-processing method and apparatus according to an embodiment of the present disclosure may use the attributes of a document image, such as a color distribution of a document image, a noise component distribution in a document image, the degree of rotation of a document in a document image, and the like, in order to measure a document quality of an input document image, and may utilize characteristics based on a character included in a document image in addition to the attributes of the document image itself.

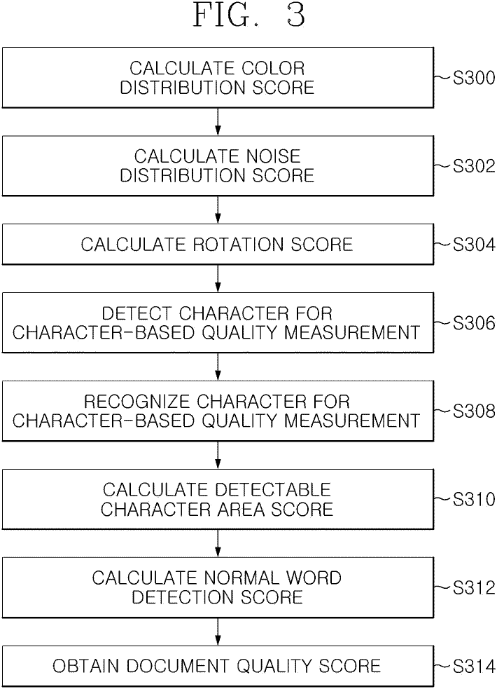

FIGS. 3 to 6, operation S200 that measures a document quality of an input document image will be described in detail.

FIG. 3 is a detailed flowchart illustrating the document quality measurement operation S200 illustrated in FIG. 2. The operations illustrated in FIG. 3 may be performed by a document quality measurement unit 1002.

The document quality measurement unit 1002 may calculate a color distribution score in operation S300, may calculate a noise distribution score in operation S302, and may calculate a rotation score in operation S304, in order to perform document image-based quality measurement. The order of operations S300 to S304 may be changed.

Subsequently, before performing character-based quality measurement, the document quality measurement unit 1002 may detect a character from the document image in operation S306, and may recognize the detected character in operation S308.

Subsequently, for the character-based quality measurement, the document quality measurement unit 1002 may calculate a detectable character area score in operation S310 and may calculate a normal word detection score in operation S312. The order of operations S310 to S312 may be changed.

In operation S314, based on at least one of the color distribution score, the noise distribution score, the rotation score, the detectable character area score, and normal word detection score, the document quality measurement unit 1002 may obtain a document quality score of an input document image.

Only based on document image-based quality measurement, the document quality measurement unit 1002 may obtain the document quality score of the input document image. In this instance, operations S306 to S312 for character-based quality measurement may not be performed.

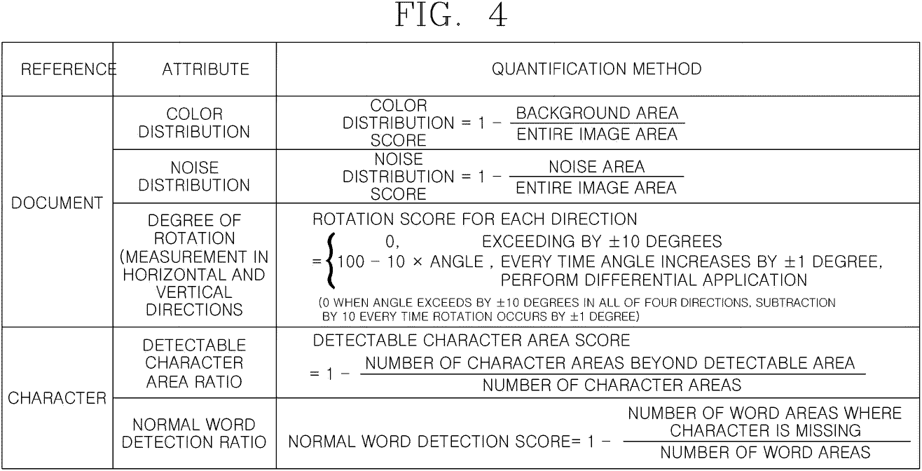

FIG. 4 is a diagram illustrating examples of attribute items measurable in the case of document image-based measurement (or document-based measurement) and character-based measurement to which reference may be made when a document quality of a document image is measured. In operation S200 that measures a document quality, the document quality measurement unit 1002 may calculate a score of each of the document quality measurement attribute items illustrated in FIG. 4, may set a weight value for each item so that the total sum of weight values is 1, may apply a weight value for each item, may obtain an average of scores of the document quality measurement attribute items, as shown in Equation 1, and may quantify the degree of a final document quality of the document image as a document quality score.

$$\begin{matrix}\text{document quality score =} {\sum }_{\text{i}} \left(\text{weight value i} \times \text{each attribute score i}\right) \\ / \text{number of refeence items}\end{matrix}$$

i is 1 to the number of reference items. For example, in case that the number of reference items is 5, and i may be 1 to 5.

First, document image-based (document-based) attribute items may be calculated as below.

In the case of measurement of a color distribution, an input document image may be separated as a character area and a background area, and the color distribution may be measured based on a ratio corresponding to the background area where relatively various colors are distributed when compared to the character area. In order to separate a character and a background, both a foreground/background separation based on an image processing algorithm and a foreground/background separation method using a deep learning model may be applicable.

As illustrated in FIG. 4, a color distribution may be quantified based on a color distribution score obtained by (1-background area/entire image area). The quantified color distribution score may express the state of a document image, such as ‘normal’, ‘color difference (dark or light) ‘, ‘spread or stain’, ‘crumpled or ripped’, and the like.

A noise distribution may be calculated via subtraction between an input document image and a result extracted by applying an appropriate noise filter, such as Gaussian filter, Laplacian filter, and the like, to the input document image, may be calculated by comparing similarity between adjacent pixels in the input document image, or may be measured by converting the input document image into data in the frequency domain via Fourier transform, and measuring a degree that corresponds to a low-frequency area or a high-frequency area.

As illustrated in FIG. 4, the noise distribution may be quantified based on a noise distribution score obtained by (1- noise area/ entire image area).

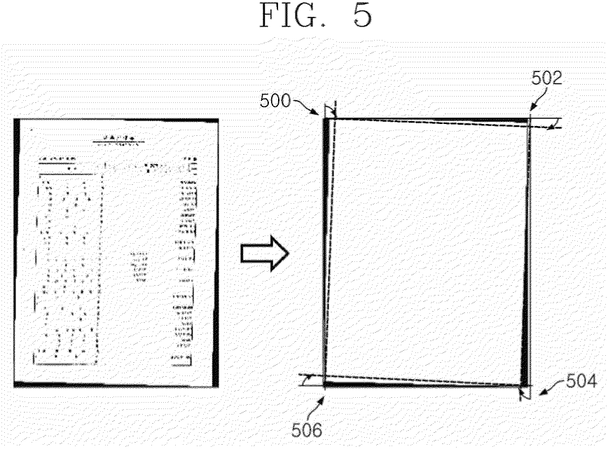

A degree of rotation of a document in a document image may be calculated by detecting a line existing inside an input document image and measuring, for each edge 500, 502, 504, and 506, an angle based on a horizontal line in a horizontal direction and an angle based on a vertical line in a vertical direction, as illustrated in FIG. 5, and using a calculation formula described in the rotation degree quantification method illustrated in FIG. 4 that quantifies the measured angle in units of ±1 degrees. Configuration may be performed so that the document image is classified as a low-quality image when the degree of rotation exceeds a predetermined angle, for example, a rotation of ±10 degrees, for each direction of the document in the calculation formular. However, a reference value such as ±10 degrees may be changeable depending on an environment where a reference value is applied.

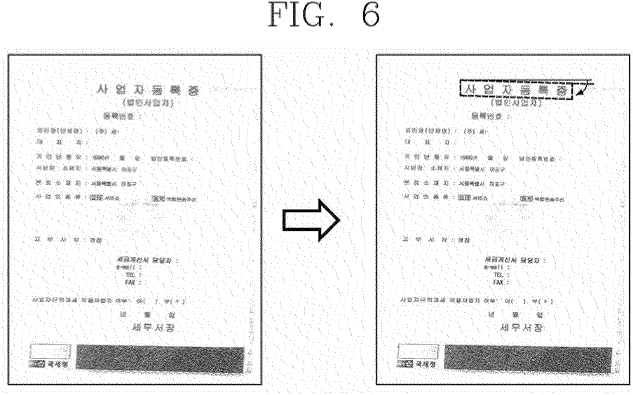

In addition, in case that a line is not present in the document, the degree of rotation of the document may be calculated by detecting a boundary area (bounding box) based on a character or a word as illustrated in FIG. 6, and detecting the degree of rotation of the corresponding area.

That is, as illustrated in FIGS. 4 and 5, if the degree of rotation in the horizontal direction and the vertical direction for each edge 502, 504, 506, and 508 of the document in the document image exceeds a predetermined angle (±10 degrees), the degree of rotation may be quantified as 0. If the degree of rotation in the horizontal direction and the vertical direction is less than the predetermined angle (±10 degrees), the degree of rotation may be quantified by an average of rotation scores of edges 502, 504, 506, and 508 obtained by (100-10× degree of rotation).

Character-based attribute items may be calculated as follows.

As illustrated in FIG. 4, a detectable character area ratio may be quantified by a detectable character area score obtained by (1-the number of character areas beyond the detectable area/ the number of character areas).

In addition, as illustrated in FIG. 4, a normal word detection ratio may be quantified by a normal word detection score obtained by (1-the number of word areas where a character is missing/the number of word areas).

For example, in case that characters “description of the present invention” are present in a document image, the number of character areas, which means the number of characters excluding blanks, is 32, and the number of word areas, which means the number of words excluding blanks, is 5.

In case that “n” is missing from “invention” and “on” is missing from “description”, the number of missing characters is 3 and thus, the number of character areas beyond a detectable area is 3, and the number of words where a character is missing is 2 and thus, the number of word areas where a character is missing is 2.

Referring again to FIGS. 2 and 10, in operation S202, the document quality classification unit 1004 may classify, based on the document quality score of the input document image obtained in operation S314 of FIG. 3, the document quality of the input document image as at least one of a high quality, a medium quality, and a low quality.

For example, in case that the document quality score is greater than or equal to a first score, the document quality is classified as the high quality, in case that the document quality score is greater than or equal to a second score and less than the first score, the document quality is classified as a medium quality, and in case that the document quality score is less than the second score, the document quality is classified as the low quality.

Alternatively, a document quality score is obtained for each of a plurality of input document images, and based on the document quality score of each of the plurality of document images, the plurality of document images are grouped as at least one of a low-quality group, a medium-quality group, and a high-quality group. Then, based on the document quality score of the input document image and the result of grouping, the document quality of the input document image may be classified as at least one of the low quality, the medium quality, and the high quality.

For example, in case that a document quality score is obtained for each of 12 document images and the obtaining result shows that four document quality scores fall within a first score area, five document quality scores fall within a second score area, and three document quality scores fall within a third score area, three groups, that is, a low-quality group corresponding to the first score area, a medium-quality group corresponding to the second score area, and a high-quality group corresponding to the third score area may be set based on each score area.

After setting the groups, for example, in case that the document quality score of the input document image falls within the first score area, the document quality of the input document image may be classified as the low quality, in case that the document quality score of the input document image falls within the second score area, the document quality of the input document image may be classified as the medium quality, and in case that the document quality score of the input document image falls within the third score area, the document quality of the input document image may be classified as the high quality.

Subsequently, in operation S204, operation S206, and operation S208, image pre-processing corresponding to the document quality classified for the input document image may be performed.

In operation S204, operation S206, and operation S208, pre-processing operations to be applied for each document quality classified based on document quality measurement may be selectively applied.

In the image pre-processing process for each quality in operations S204, operation S206, and operation S208, in case that the document image is classified as the high-quality image in operation S204, part or the entirety of the pre-processing operations may be omitted, or in case that the document image is classified as the medium quality in operation S206 or is classified as the low quality in operation S208, another optimal correction method may be applied by performing strong noise cancellation and adjusting the degree of brightness correction based on a measured reference item so as to maximize performance in a character recognition operation.

That is, in case that the document quality of the input document image is the low quality or the medium quality, pre-processing may be performed using an optimal correction method among a plurality of correction methods used in a pre-processing operation related to at least one quality measurement item that deteriorates the quality of the input document image to the low quality or the medium quality.

For example, in the case of rotation correction, an angle is detected by detecting a line existing in a document in order to perform rotation correction. In this instance, a scheme of applying a single outline detection algorithm in order to detect the outline of an image is generally used in outline detection operation S106.

The scheme is applied without considering the color distribution or noise distribution of an image and thus, a result may differ depending on the quality of a document even when the same image is used. Therefore, the document quality-based image pre-processing method and apparatus according to an embodiment of the disclosure may apply an optimal outline detection algorithm appropriate for each document quality in the case in which the document quality is classified as the medium quality in operation S206 or is classified as the low quality in operation S208.

In addition, in many cases, if a deep neural network-based character recognizer is used, various learning data is prepared to prevent effect of rotation and thus, rotation correction may be omitted in the case of rotation falling within a predetermined range.

The image pre-processing operation S204, S206, and S208 that corresponds a document quality classified for an input document image will be described below in detail.

In case that the document quality of the input document image is the low quality, in operation S208, the low-quality image pre-processing unit 1010 may perform all pre-processing operations with respect to the input document image, and may use a high-performance pre-processing method when performing a pre-processing operation related to a quality measurement item that indicates a score less than or equal to a predetermined score among scores associated with quality measurement items.

For example, in case that the document quality of the input document image is the low quality, in operation S208, the low-quality image pre-processing unit 1010 may perform all pre-processing operations illustrated in FIG. 1, that is, brightness correction operation S100, size correction operation S102, color correction operation S104, outline detection operation S106, rotation determination operation S108, rotation correction operation S110, noise cancellation operation S112, and binarization operation S114.

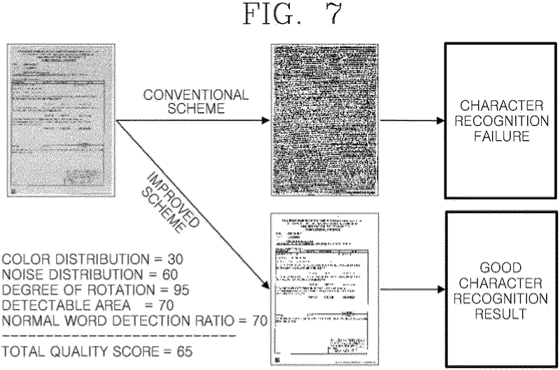

In addition, as illustrated in FIG. 7, in case that the quality score of an input document image is 65 points and the quality of the document image is determined as the low quality, the low-quality image pre-processing unit 1010 may apply a binarization method showing relatively high binarization performance such as an OTSU binarization algorithm, instead of an existing binarization method that simply applies a threshold value, when applying a binarization method of binarization operation S114 among the pre-processing operations. Therefore, as illustrated in FIG. 7, although the quality of an input document image is the low quality, a good character recognition result may be obtained.

Referring to FIG. 7, in case that a low-quality document image is input, the existing method may use a binarization method that simply applies a threshold value and thus, it is recognized that character recognition fails. Conversely, a document quality-based image pre-processing method according to the present disclosure may apply, for example, OTSU binarization algorithm that shows excellent binarization performance and thus, it is identified that a character recognition result is good.

According to a document quality-based image pre-processing method according to an embodiment of the present disclosure as described above, character recognition performance may be improved by applying pre-processing to which an appropriate algorithm is applied based on the measured quality score of a document image by considering values, obtained by measuring for each of document image-based attribute or character-based attribute, together. For example, in binarization operation S114 that is the last operation of the pre-processing of FIG. 1, an optimal binarization algorithm is applied to a document image and thus, a good character recognition result may be obtained even when the quality of the document image is the low quality.

In addition, in case that the quality of an input document image is the low quality, another algorithm that maximizes the performance of an character recognition operation may be applied, for example, strongly performing of noise cancellation using a noise cancellation method showing high noise cancellation performance in noise cancellation operation S112 in case that noise is widely distributed in the document image or adjustment of the degree of brightness correction in brightness correction operation in operation S100.

In case that the document quality of the input document image is the medium quality, in operation S206, the medium-quality image pre-processing unit 1008 may omit at least one pre-processing operation related to at least one quality measurement item that contributes to classification of the input document image as a medium quality document image, and may use a high-performance preprocessing method when performing a pre-processing operation related to a quality measurement item showing a low score less than or equal to a predetermined score among scores associated with quality measurement items.

For example, in case that the document quality of the input document image is the medium quality and a quality measurement item that contributes to classification of the document image as a medium-quality image is the degree of rotation, the quality image pre-processing unit 1008 may perform brightness correction operation S100, size correction operation S102, color correction operation S104, noise cancellation operation S112, and binarization operation S114 among the pre-processing operations illustrated in FIG. 1, and may omit outline detection operation S106 that corresponds to pre-processing operations related to the degree of rotation, rotation determination operation S108, and rotation correction operation S110, in operation S206. Therefore, since some unnecessary pre-processing operations in the pre-processing process are omitted and thus, an unnecessary operation may be reduced, a pre-processing speed may be increased, and a processing time may be decreased.

In addition, in case that the quality of the input document image is the medium quality and a noise distribution score is low, that is, noise is widely distributed in the document image, another algorithm that maximizes the performance of a character recognition operation may be applied, such as, strongly performing of noise cancellation using a noise cancellation method showing high noise cancellation performance in noise cancellation operation S112.

In case that the document quality of the input document image is the high quality, the high-quality image pre-processing unit 1006 may omit the entirety of the pre-processing operations illustrated in FIG. 1 or part or the entirety of pre-processing operations corresponding to quality measurement items, in operation S204.

For example, in case that the document quality of the input document image is the high quality and the high-quality image pre-processing unit 1006 may omit the entirety of the pre-processing operations illustrated in FIG. 1, or may omit color correction operation S104, outline detection operation S106, rotation determination operation S108, rotation correction operation S110, and noise cancellation operation S112 among the pre-processing operation illustrated in FIG. 1.

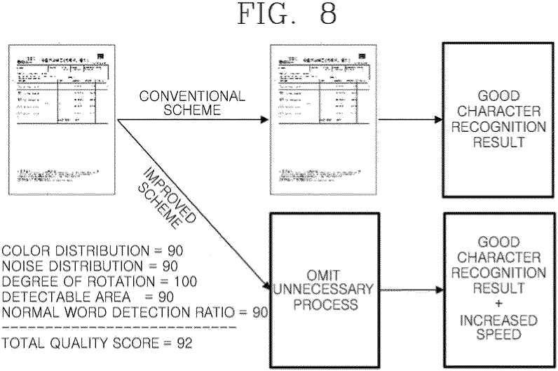

Therefore, in the case of an input document image classified as a high-quality image as illustrated in FIG. 8, the entire pre-processing process or some unnecessary pre-processing operations of the pre-processing process may be omitted and thus, an unnecessary operation may be reduced, a pre-processing speed may be improved, and a processing time may be decreased.

In operation S210, the character recognition unit 1012 may recognize a character from a pre-processed document image.

A document quality-based image pre-processing method according to an embodiment of the above-described present disclosure may be embodied as computer-readable code in a computer-readable storage medium storing instructions configured to enable an apparatus including a processor to implement operations for a document quality-based image pre-processing, when the instructions are executed by the processor. The computer-readable storage medium may continuously store a computer-executable program, or may temporarily store the same for execution or downloading. In addition, a storage medium may be one of the various types of recording devices or storage devices provided in a single entity or in a form in which a plurality of pieces of hardware are combined, and the storage medium is not limited to a medium that directly accesses a predetermined computer system, and may be distributed in a network. Therefore, the detailed description should not be construed restrictively in all aspects, and may be considered as an example. The scope of the disclosure should be determined by rational interpretation of attached claims, and all modifications made in the scope equivalent to that of the present disclosure should be included in the scope of the present disclosure.

The present disclosure may not be limited to the above-described embodiments and attached drawings, but may be embodied in another specific form. It is apparent to those skilled in the art field to which the present disclosure belongs that elements of the present disclosure are capable of being replaced, modified, and changed within a scope without departing from the technical idea of the present disclosure.

What is claimed is:

1. A document quality-based image pre-processing method performed by a processor in an apparatus, the method comprising:
measuring a document quality of an input document image;
classifying the document quality; and
performing image pre-processing corresponding to the document quality classified for the document image.

2. The method of claim 1, wherein the measuring of the document quality comprises measuring the document quality based on at least one of an attribute of the document image and an attribute of a character included in the document image.

3. The method of claim 1, wherein the attribute of the document image comprises at least one of a color distribution, a noise distribution, and a degree of rotation associated with the document image, and
the attribute of the character comprises at least one of a detectable character area ratio and a normal word detection ratio.

4. The method of claim 1, wherein the measuring of the document quality of the input document image further comprises:
detecting a character from the document image; and
recognizing the detected character.

5. The method of claim 1, wherein the classifying of the document quality comprises classifying, based on the measured document quality, the document quality of the input document image as one of a high quality, a medium quality, and a low quality.

6. The method of claim 5, wherein the performing of image pre-processing corresponding to the document quality classified for the document image comprises:
in case that the document quality of the input document image is the low quality, performing entire pre-processing on the input document image;
in case that the document quality of the input document image is the medium quality, omitting pre-processing related to at least one quality measurement item that contributes to classification of the document image as the medium quality; and
in case that the document quality of the input document image is the high quality, omitting part or the entirety of the pre-processing.

7. The method of claim 5, wherein performing of the image pre-processing corresponding to the document quality classified for the document image comprises:
in case that the document quality of the input document image is the low quality or the medium quality, performing pre-processing using an optimal correction method among a plurality of correction methods used in pre-processing related to at least one quality measurement item that deteriorates the quality of the document image to the low quality or the medium quality.

8. The method of claim 5, wherein the measuring of the document quality of the input document image further comprises:
obtaining a score of each quality measurement item for the input document image; and
obtaining an average of the scores of the quality measurement items, and acquiring a document quality score, and
wherein the classifying of the document quality comprises classifying, based on the document quality score, the document quality of the input document image as at least one of the high quality, the medium quality, and the low quality.

9. The method of claim 5, wherein the measuring of the document quality of the input document image further comprises:
acquiring a document quality score for each of a plurality of input document images; and
based on the document quality score of each of the plurality of document images, setting at least one of a low-quality group, a medium-quality group, and a high-quality group, and
wherein the classifying of the document quality comprises classifying, based on the document quality score of the input document image and the set group, the document quality of the input document image as at least one of the low quality, the medium quality, and the high quality.

10. The method of claim 3, wherein the document quality of the document image is measured based on at least one of a color distribution score, the noise distribution score, the rotation score, a detectable character area score, and a normal word detection score obtained by quantifying the color distribution, the noise distribution, the degree of rotation, the detectable character area ratio, and the normal word detection ratio, respectively.

11. The method of claim 10, wherein the color distribution score is obtained by (1-background area/entire image area), the noise distribution score is obtained by (1-noise area/entire image area), the rotation score is 0 in a case that a degree of rotation of each edge of a document in the document image in a horizontal direction and a vertical direction is greater than a predetermined angle, and is obtained by (100-10×degree of rotation) in a case that the degree of rotation in the horizontal direction and the vertical direction is less than the predetermined angle, the detectable character area score is obtained by (1-the number of character areas that are beyond a detectable area/the number of character areas), and the normal word detection score is obtained by (1-the number of word areas where a character is missing/the number of word areas).

12. A document quality-based image pre-processing apparatus comprising a processor,
wherein the processor is configured to perform:
measuring a document quality of an input document image;
classifying the document quality; and
performing image pre-processing corresponding to the document quality classified for the document image.

13. The apparatus of claim 12, wherein the measuring of the document quality of the input document image comprises measuring the document quality based on at least one of an attribute of the document image and an attribute of a character included in the document image.

14. The apparatus of claim 12, wherein the attribute of the document image comprises at least one of a color distribution, a noise distribution, and a degree of rotation associated with the document image, and
the attribute of the character comprises at least one of a detectable character area ratio and a normal word detection ratio.

15. The apparatus of claim 12, wherein the measuring of the document quality of the input document image further comprises:
detecting a character from the document image; and
recognizing the detected character.

16. The apparatus of claim 12, wherein the classifying of the document quality comprises:
classifying, based on the measured document quality, the document quality of the input document image as at least one of a high quality, a medium quality, and a low quality.

17. The apparatus of claim 16, wherein the performing of image pre-processing corresponding to the document quality classified for the document image comprises:
in a case that the document quality of the input document image is the low quality, performing entire pre-processing on the input document image;
in a case that the document quality of the input document image is the medium quality, omitting pre-processing related to at least one quality measurement item that contributes to classification of the document image as the medium quality; and
in a case that the document quality of the input document image is the high quality, omitting part or the entirety of the pre-processing.

18. The apparatus of claim 16, wherein the performing of the image pre-processing corresponding to the document quality classified for the document image comprises:
in a case that the document quality of the input document image is the low quality or the medium quality, performing pre-processing using an optimal correction method among a plurality of correction methods used in pre-processing related to at least one quality measurement item that deteriorates the quality of the document image to the low quality or the medium quality.

19. The apparatus of claim 16 wherein the measuring of the document quality of the input document image further comprises:
obtaining a document quality score for each of a plurality of input document images; and
based on the document quality score for each of the plurality of document images, setting at least one of a low-quality group, a medium-quality group, and a high-quality group, and
wherein the classifying of the document quality comprises classifying, based on the document quality score of the input document image and the set group, the document quality of the input document image as at least one of the low quality, the medium quality, and the high quality.

20. A computer-readable storage medium that stores instructions which, when executed by a processor, cause an apparatus comprising the processor to perform operations for document quality-based image pre-processing, the operations comprising:
measuring a document quality of an input document image;
classifying the document quality; and
performing image pre-processing corresponding to the document quality classified for the document image.
